(19) United States
(12) Patent Application Publication
(10) Pub. No.: US 2014/0366830 A1
(43) Pub. Date: Dec. 18, 2014

(54) ENGINE-POWERED TOOL

(71) Applicant: HITACHI KOKI CO., LTD., Tokyo (JP)

(72) Inventors: Yoshikazu Kawano, Hitachinaka (JP); Takuhiro Murakami, Hitachinaka (JP)

(21) Appl. No.: 14/374,189

(22) PCT Filed: Jan. 23, 2013
(86) PCT No.: PCT/JP2013/000333

§ 371 Date: Jul. 23, 2014

(30) Foreign Application Priority Data
Jan. 24, 2012 (JP) 2012-011597

(51) Int. Cl. F02B 63/02; F02N 11/00

(52) U.S. Cl. CPC F02B 63/02; F02N 11/00
USPC 123/179.3

(57) ABSTRACT

An engine-powered tool 1 includes a starter motor 106 to be driven by electric power supplied from a battery 80 to start an engine, start control means 102 to be driven by electric power from the battery 80 to control rotation of the starter motor 106, and a switching element (FET) 121 provided in series to a power supply circuit from the battery 80 to the starter motor 106, opening and closing of the switching element being controlled by the start control means. When starting the starter motor 106, PWM control is performed on the switching element and soft start in which a duty ratio is gradually increased is performed. The start control means 102 monitors temperature and battery voltage, and changes a ratio and time for increasing the duty ratio in the PWM control in accordance with the temperature and the voltage.

### TECHNICAL FIELD

The present invention relates to an engine-powered tool such as a chainsaw or a grass cutter, and particularly relates to an engine-powered tool started by driving a starter motor by use of a small-sized battery.

### BACKGROUND ART

For small-sized power tools such as a chainsaw and a grass cutter, a small-sized engine has been widely used as a power source. FIG. 6 is an external view of a grass cutter serving as an example of a conventional engine-powered tool 101. As shown in FIG. 6, the engine-powered tool 101 having a small-sized two-cycle engine mounted thereon has a drive shaft (not shown) penetrating through a pipe-shaped main pipe 5, and rotates this drive shaft with an engine provided at one end of the main pipe 5 to rotate a rotary blade 6 serving as a working tool provided at the other end of the main pipe 5. Near the rotary blade 6, a scatter prevention cover 6a is provided to prevent the scatter of cut grass. The engine-powered tool 101 is carried with a shoulder strap (not shown) or the like, and a handle 4 in a substantially U shape in a front view used for the operation by a worker is attached near a longitudinal center part of the main pipe 5. The number of revolutions of the engine-powered tool 101 is controlled by the worker with a throttle lever (not shown) attached on a grip part 3. The operation of the throttle lever is transmitted to a carburetor of the engine via a wire 37.

The engine as used in the engine-powered tool 101 is small-sized and lightweight and can generate large output, and also allows a work for long hours with the supply of fuel. To start the engine, a manual starter is used, and various ideas have been suggested to improve startability. For example, Patent Literature 1 suggests an engine-powered tool in which a battery and a starter motor are incorporated and startability is improved by the starter motor.

### CITATION LIST

### Patent Literature

PTL 1: Japanese Patent No. 3400191

### SUMMARY OF INVENTION

### Technical Problem

In the engine-powered tool of Patent Literature 1, if a battery having a size sufficient for driving the starter motor is mounted, portability of the engine-powered tool is degraded. To address this, it seems effective to mount a small-sized battery with a low battery voltage. However, since a large current is required for driving the starter motor, the starting current at the time of starting the motor puts a large load on the battery, and the life of the battery may be shortened. Moreover, at the time of low temperatures, the battery voltage is significantly lowered due to this starting current, and there is a possibility that the starter motor cannot be rotated.

An object of the present invention is to provide a lightweight, inexpensive engine-powered tool equipped with a battery and a starter motor.

Another object of the present invention is to provide an engine-powered tool capable of decreasing the size of a battery to be mounted by devising the control at the time of starting a starter motor.

Still another object of the present invention is to provide an engine-powered tool capable of driving a starter motor even with a battery whose voltage has been lowered.

### Solution to Problem

Typical ones of features of the present invention disclosed in the present application are described as follows.

An embodiment of the present invention is an engine-powered tool to be driven by an engine, and the engine-powered tool includes: a starter motor driven by electric power supplied from a battery to start the engine; start control means driven by the electric power from the battery to control rotation of the starter motor; and a switching element provided in series to a power supply circuit from the battery to the starter motor, opening and closing of the switching element being controlled by the start control means. In this engine-powered tool, when the starter motor is to be started, the start control means performs PWM control on the switching element so as to gradually increase a duty ratio. Also, the engine-powered tool further includes: switch means for operating the engine, and when the switch means is turned ON, electric power is supplied from the battery to the start control means, and power supply to the starter motor is controlled by the start control means.

### Advantageous Effects of Invention

In the engine-powered tool, when the starter motor is to be started, the start control means performs PWM control on the switching element so as to gradually increase the duty ratio. Thus, so-called soft start of the starter motor can be performed, thereby suppressing an excessive starting current.

The above and other objects and novel characteristics of the present invention will be apparent from the following description of the specification and the accompanying drawings.

### BRIEF DESCRIPTION OF DRAWINGS

FIG. 1 is a longitudinal sectional view of an inner structure of an engine-powered tool according to an embodiment of the present invention.

FIG. 2 is a rear view of the engine-powered tool according to the embodiment of the present invention.

FIG. 3 is a circuit diagram of a control unit of the engine-powered tool according to the embodiment of the present invention.

FIG. 4 is a flowchart showing a start procedure of the engine-powered tool according to the embodiment of the present invention.

FIG. 5 shows waveform diagrams illustrating a relation among the state of a starter switch, a conduction state of a FET, and the number of revolutions of a starter motor when the starter motor is to be started in the engine-powered tool.

FIG. 6 is a perspective view of a grass cutter as an example of a conventional engine-powered tool.

### DESCRIPTION OF EMBODIMENTS

An engine-powered tool 1 according to an embodiment of the present invention is described below based on the drawings. Note that, in the drawings described below, identical portions are denoted by the same reference numeral and repetitive description thereof is omitted. Also, in the description in this specification, directions of front, back, left, right, up, and down are defined as those indicated in the drawings.

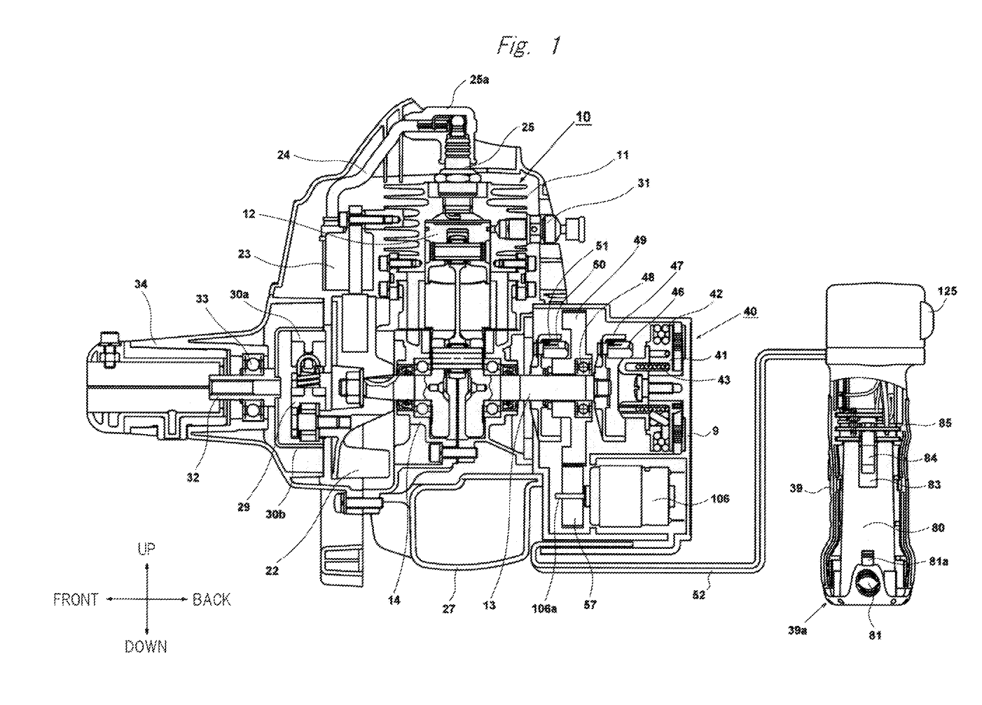

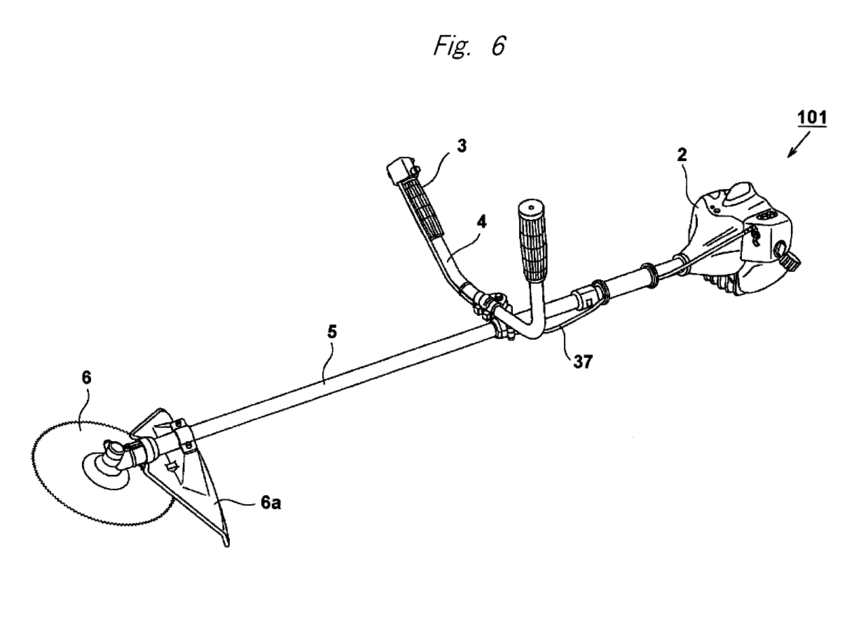

FIG. 1 is a longitudinal sectional view of an inner structure of the engine-powered tool 1 according to an embodiment of the present invention. An engine 10 is a two-cycle small engine, in which a crank shaft 13 is coaxially arranged with a main pipe 5 (see FIG. 6), a cylinder 11 is arranged so as to extend from a crank case 14 upward in a substantially vertical direction, and a piston 12 reciprocates in an up-and-down direction in the cylinder 11. A high-voltage current generated at an ignition coil 23 is transmitted via an ignition code 24 and a plug cap 25a to an ignition plug 25. Below the crank case 14 of the engine 10, a fuel tank 27 is provided. The fuel tank 27 contains a mixed oil of gasoline and oil for two cycles, and it is sent to a carburetor 35 described further below.

To a front side (output side) of the crank shaft 13, one end of a drive shaft (not shown) via a centrifugal clutch 29 is coupled via a clutch shaft 32. On a magneto rotor 22 to which the centrifugal clutch 29 is attached, a fin for cooling the engine is integrally formed. The centrifugal clutch 29 is a publicly-known centrifugal clutch in which a rocker 30a is connected to a clutch drum 30b by a centrifugal force when the number of revolutions of the crank shaft 13 reaches a predetermined number or larger. The clutch shaft 32 is rotatably held by a bearing 33 retained in a housing 34.

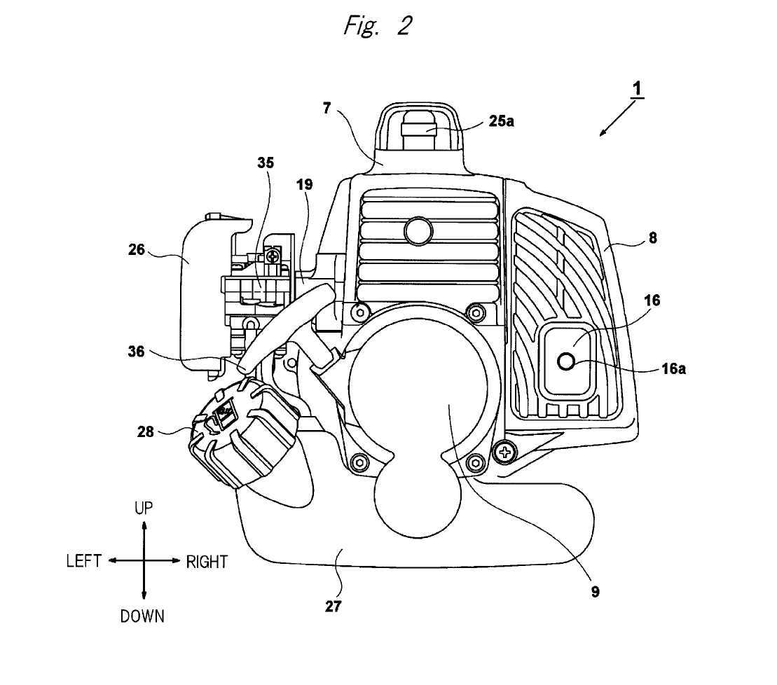

The engine-powered tool includes two systems of a starter motor 106 and a recoil starter 40 as a starting device. The starter motor 106 rotates by electric power supplied via an electric power line 52, and a pinion 57 provided on a rotation shaft 106a is rotated to rotate a gear 49. The gear 49 is rotatably held by a bearing 48 to the crank shaft 13. When the gear 49 rotates at high speed, a one-way clutch 50 attached on a part of the gear 49 protrudes in a radially outer direction by a centrifugal force to make close contact with a first drum 51 to rotate the first drum 51, thereby rotating the crank shaft 13. In the recoil starter 40, when a starter rope 42 wound around a reel 41 is rotated at high speed by a starter handle 36 (see FIG. 2 described further below), a one-way clutch 46 protrudes in a radially outer direction by a centrifugal force to make close contact with a second drum 47 to rotate the second drum 47. Since the second drum 47 is fixed to the crank shaft 13, when the second drum 47 rotates, the crank shaft 13 also rotates, and thus the engine can be started. The released starter rope 42 is reeled in the reel 41 by a resilient force of a spiral spring 43.

A battery holder unit 39 is separately provided from, for example, two grip parts 3 (see FIG. 6) gripped by a worker, and is removably provided to, for example, a handle 4. The engine-powered tool 1 further has a switch 110 (not shown), which will be described further below, for starting a control circuit 102 (which will be described further below) for starting. When the engine 10 is to be started, the switch 110 is turned ON and then a starter switch 125 is pressed, thereby rotating the starter motor 106 to start the engine. When the engine 10 in operation is to be stopped, a stop switch 38 (which will be described further below) is switched to “operate” to “stop”, thereby stopping the engine 10. Inside the battery holder unit 39, a battery 80 in a substantially cylindrical shape which is mountable and removable is accommodated. The battery 80 has a substantially cylindrical shape and is configured to be of a so-called cassette type so that it is mountable on and removable from the battery holder unit 39. On the battery 80, two latch parts 81a are formed, and hold the battery 80 by engaging with recessed parts (not shown) formed on an inner wall of the battery holder unit 39. When the battery 80 is to be removed, the battery 80 is withdrawn from the battery holder unit 39 while pressing a release button 81.

Inside the battery 80, for example, three lithium-ion battery cells (not shown) of a 14500 size are accommodated. The battery 80 has a rear end (on a lower side in the drawing) shaped so as to cover an opening 39a at a lower end of the battery holder unit 39. At the other end of an insertion space of the battery 80 continued from the opening 39a, a terminal base 85 is provided, and a plurality of terminals 84 are provided so as to extend from the terminal base 85 toward the opening 39a. At a front end (on an upper side in the drawing) of the battery 80, a plurality of terminals 83 are provided, and since the terminals 83 are brought into contact with the terminals 84 formed on a battery holder unit 39 side when the battery 80 is inserted into the battery holder unit 39, electric power of the battery 80 is supplied via the terminals 84 to the control circuit 102 described further below.

FIG. 2 is a rear view of the engine-powered tool 1. On a left side of the engine 10, the carburetor 35 is provided via an insulator 19 to which an intake air port of the engine 10 is connected. On a left side of the carburetor 35, an air cleaner cover 26 forming a storage space of an air cleaner for filtering the intake air is provided. On a right side of the engine 10, a muffler 16 is provided, and on a rear surface side of the muffler 16, an exhaust air port 16a serving as an outlet of exhaust gas is provided. The muffler 16 is covered with a resin-made muffler cover 8 so as to prevent the worker from directly touching the muffler 16. An upper part of the engine 10 is covered with an upper cover 7. The recoil starter 40 (see FIG. 1) is coaxially provided at a rear end of the crank shaft 13, and the recoil starter 40 is covered with a starter case 9. In this engine-powered tool 1, since not only the recoil starter 40 but also the starter motor 106 (see FIG. 1) is provided, the starter case 9 has a gourd-like shape configured by coupling a portion covering the recoil starter 40 and a portion covering the starter motor 106 when viewed from behind as illustrated in FIG. 2. On a left side of the starter case 9, the starter handle 36 is provided. On a lower side of the crank case 14, the fuel tank 27 is provided. The fuel tank 27 is a container made of translucent high-polymer resin, and by taking off a cap 28 attached to an opening, a mixed fuel made by mixing gasoline and oil at a predetermined ratio can be poured therein.

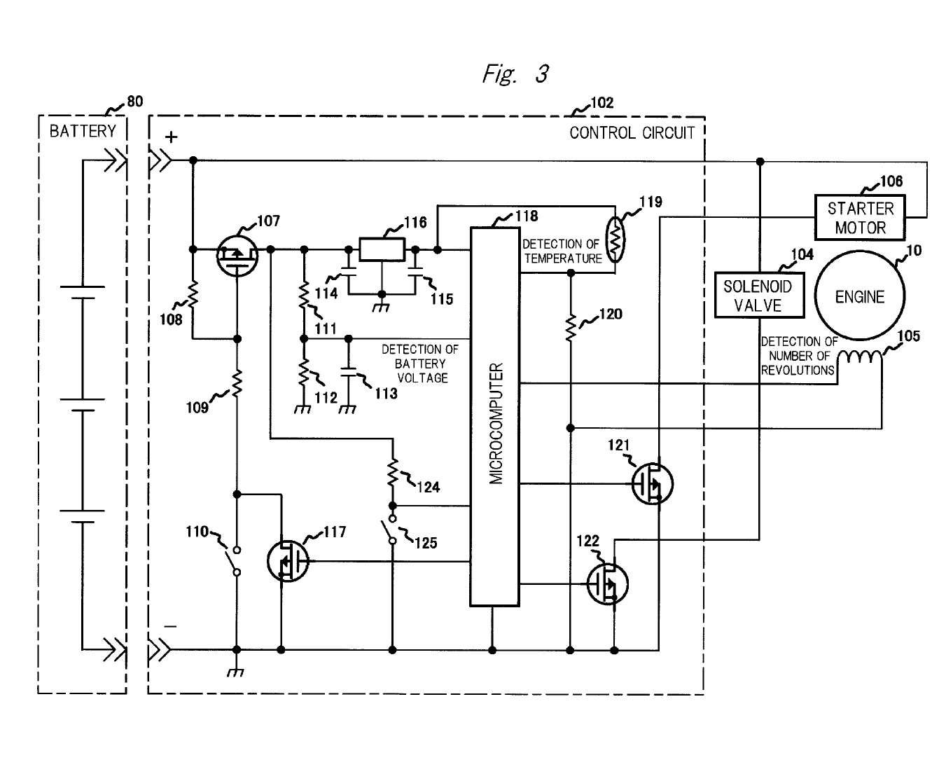

FIG. 3 is a circuit diagram of a control unit of the engine-powered tool 1. The engine-powered tool 1 is provided with the starter motor 106 for starting the engine 10, and has the battery 80 for driving the starter motor 106 connected thereto. Also, a solenoid valve 104 is provided to start the engine 10, and it functions as choke means (auto-choke) at the time of starting. The starter motor 106 and the solenoid valve 104 are controlled by the control circuit (start control means) 102, and a rotation detection coil 105 for detecting the number of revolutions of the engine 10 for the control by the control circuit 102 is provided near an outer periphery of the magneto rotor 22 (FIG. 1). The control circuit 102 is configured to include four FETs 107, 117, 121, and 122, resistors 108, 109, 111, 112, 120, and 124, switches 110 and 125, capacitors 113, 114, and 115, a regulator 116, a microcomputer 118, and a thermistor 119.

The microcomputer 118 is driven with a constant voltage supplied by the regulator 116, and has a plurality of A/D conversion ports to which an output signal from the thermistor 119 indicating the temperature of the engine, a terminal voltage of the resistor 124 for detecting an open or close state of the starter switch 125, signals from the resistors 112 and 114 indicating the voltage of the battery 80, and an output signal from the rotation detection coil 105 are inputted. An engine rotation signal is detected by converting a magnetic flux from a magnet attached to the engine 10 into a voltage by the rotation detection coil 105 and inputting the resultant voltage to the micro-computer 118. The microcomputer 118 performs a predetermined logical operation from these input values, and sends gate signals of the FETs 117, 121, and 122, thereby controlling the conduction or non-conduction between the source and the drain of the FETs 117, 121, and 122.

The FET 121 serves as a switch for rotating the starter motor 106. By an instruction from the microcomputer 118 (supply of gate signal), the source and the drain of the FET 121 become in a conduction state, and a DC current from the battery 80 is supplied to the starter motor 106 made up of a DC motor. The microcomputer 118 detects the number of revolutions of the engine 10 from an output value of the rotation detection coil 105, and when the engine is started by the starter motor 106, the source and the drain of the FET 121 is closed to stop the rotation of the starter motor 106.

The FET 122 serves as a switch for opening the solenoid valve 104. By an instruction from the microcomputer 118 (supply of gate signal), the source and the drain of the FET 122 become in a conduction state to open the solenoid valve 104. The solenoid valve 104 is provided near the carburetor 35 and the insulator 19, and by opening the solenoid valve 104 at the time of starting, an enriched fuel is supplied to the intake air port of the engine 10, and the startability can be improved.

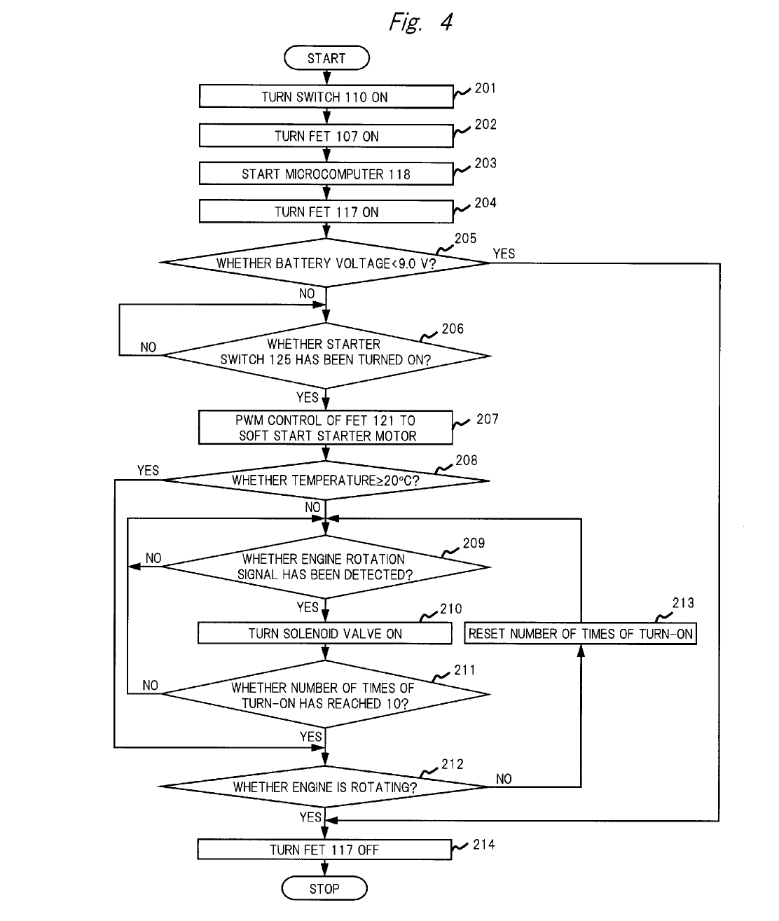

Next, a series of operations of the engine-powered tool 1 is described with reference to a flowchart of FIG. 4. Firstly, when the switch 110 serving as a power switch for the starting device is pressed (step 201), a gate voltage of the FET 107 is applied by the resistors 108 and 109, the FET 107 is turned into an ON state (step 202), and a voltage is supplied to the regulator 116. The regulator 116 is a constant voltage source, and supplies a constant voltage to the microcomputer 118 and others. The capacitors 114 and 115 are to stabilize an output voltage of the regulator 116.

When a predetermined voltage is inputted to a power supply terminal of the microcomputer 118, the microcomputer 118 is started (step 203). Next, the microcomputer 118 supplies a gate signal to turn the FET 117 ON (achieves conduction between the source and the drain), thereby keeping the ON state of the FET 107 even after the switch 110 is released (step 204).

Next, the microcomputer 118 measures a battery voltage (step 205). In the engine-powered tool 1, the battery 80 has a rated voltage of 10.8 V from three lithium-ion batteries each having a rated voltage of 3.6 V connected in series. The battery voltage is measured by smoothing a voltage divided by the resistors 111 and 112 by the capacitor 113 and inputting the resultant voltage to an A/D conversion input terminal of the microcomputer 118. Here, it is determined whether the battery voltage is, for example, 3.0 V or lower per cell, that is, whether the battery voltage is 9.0 V or lower in total because the three batteries are provided in this case (step 205). If the detected battery voltage is 9.0 V or lower, it is determined that the batteries are in a discharge state, and the procedure goes to step 214, where the FET 117 is turned OFF and the power supply of the control circuit 102 is shut down. On the other hand, if the detected battery voltage is higher than 9.0 V, the procedure goes to step 206.

Next, at step 206, it is determined whether the starter switch 125 has been pressed (turned ON). Here, if the starter switch 125 still remains in an OFF state, the microcomputer 118 waits until the starter switch 125 is turned ON. When the starter switch 125 is turned ON, the microcomputer 118 supplies a predetermined DC current to the starter motor 106 while performing PWM (Pulse Width Modulation) control on the FET 121, thereby soft-starting the starter motor 106 (step 207). Here, soft start means that the rotation of the starter motor 106 is moderately started while restricting the starting current of the starter motor 106 to suppress an excessive current flowing at the time of starting.

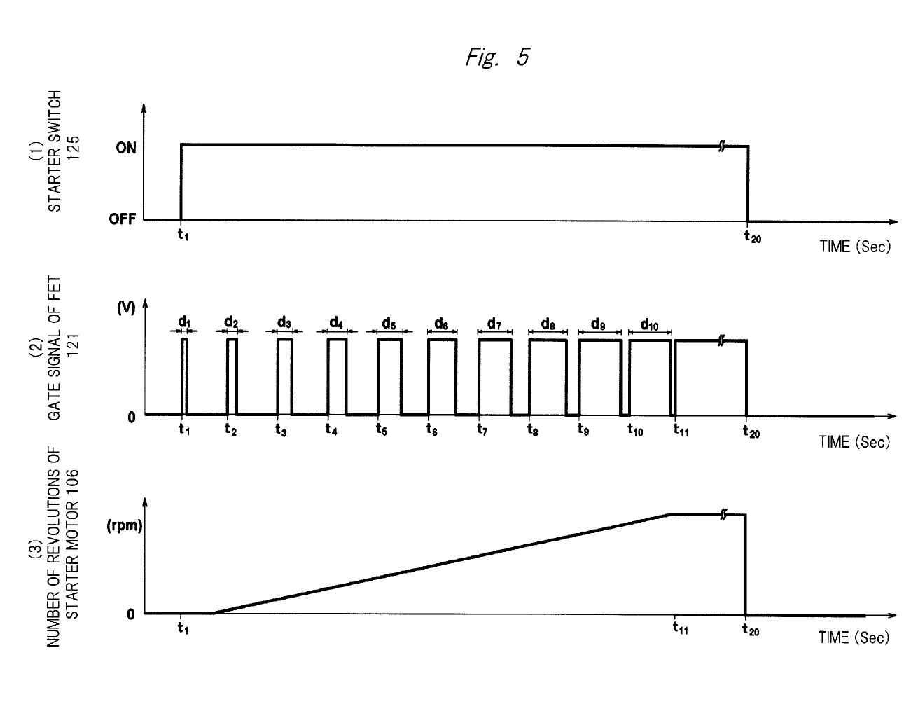

Control of the microcomputer 118 at this soft start is described with reference to FIG. 5. FIG. 5 shows waveform diagrams illustrating a relation among the state of the starter switch 125, a conduction state of the FET 121, and the number of revolutions of the starter motor 106 when the starter motor 106 is to be started. FIG. 5 (1) shows a waveform diagram illustrating a conduction state of the starter switch 125, and the starter motor 106 rotates from a time t₁ when the starter switch 125 is turned ON to a time t₂₀ when the starter switch 125 is turned OFF. Note that the starter motor 106 may rotate only during a period in which the starter switch 125 is being pressed, but since the engine-powered tool 1 includes the microcomputer 118, the starter motor 106 can be configured to be driven only for a predetermined period of time from when the starter switch 125 is pressed. It is also possible to configure the starter motor 106 so that the rotation thereof is stopped when the start of the engine is detected by the microcomputer 118 during a predetermined period of time. As another control method, while the starter motor 106 is configured to rotate only during a period in which the starter switch 125 is being pressed, the starter motor 106 may be controlled so as not to rotate when the start of the engine is detected by the microcomputer 118 even if the starter switch 125 is kept being pressed.

FIG. 5 (2) shows a signal for the microcomputer 118 to supply a gate signal of the FET 121, and the signal is turned ON (high potential) only for a predetermined time dₙ from a time tₙ (n is an integer and n=1 to 11 in the present embodiment). This time dₙ when the signal is turned ON is gradually increased as n is increased, and is adjusted so that a duty ratio (=dₙ/(tₙ₊₁−tₙ)*100) eventually becomes 100%. With this control, the starter motor 106 can be moderately or gradually started while suppressing an increase in starting current of the starter motor 106. Then, when the microcomputer 118 detects the start of the engine 10 at the time t₂₀, the FET 117 is turned OFF to stop the starter motor 106, and the power supply of the control circuit 102 is shut down. Note that the microcomputer 118 may control the time, the number of steps, and others for changing the duty ratio to reach 100% so as to be changed as appropriate in accordance with ambient temperature and battery voltage.

Referring back to FIG. 4, at step 208, the microcomputer 118 detects temperature from an output signal of the thermistor 119. In this temperature detection, the temperature is measured by inputting the voltage divided by the thermistor 119 and the resistor 120 to the A/D conversion input terminal of the microcomputer 118. If the temperature measured by the microcomputer 118 is a predetermined value (for example, 20 deg C.) or higher, the procedure goes to step 212. This is because if the temperature is 20 deg C. or higher, additional injection of the fuel by the solenoid valve 104 is not necessary, and conversely, if additional injection of the fuel is made, plug fouling may occur. If the measured temperature is lower than the predetermined value (for example, 20 deg C.), it is detected whether a rotation signal of the engine 10 has been detected (step 209), and the microcomputer 118 waits until it is detected. The rotation signal of the engine 10 can be detected from an output of the rotation detection coil 105. If the rotation signal of the engine 10 has been detected at step 209, the microcomputer 118 turns the solenoid valve 104 ON to additionally inject, into the cylinder, the fuel more than an amount normally supplied from the carburetor to the engine 10 (step 210).

The solenoid valve 104 is controlled so as to be opened only for a short time interval and then immediately closed. For example, this opening is made once per rotation of the crank shaft 13. Next, at step 211, the microcomputer 118 determines whether the number of times of opening and closing of the solenoid valve 104 has reached 10. Here, if the number of times of opening and closing of the solenoid valve 104 has not reached 10, the procedure returns to step 209, steps 209 to 211 are repeated, and the procedure goes to step 212 when the number of times has reached 10. The reason why the processes at steps 209 to 211 are skipped when the temperature of the engine 10 is 20 deg C. or higher at step 208 is that additional injection of the fuel by the solenoid valve 104 is not necessary if the temperature is 20 deg C. or higher. Note that it is determined at step 211 whether the number of times of opening and closing has reached 10, but the number of times is not limited to 10, and can be set as appropriate in accordance with the characteristics of the engine and others.

At step 212, the microcomputer 118 detects whether the engine 10 has started, that is, whether the engine 10 is rotating. This can be determined based on whether an engine rotation signal from the rotation detection coil 105 is periodically detected by the microcomputer 118. If the engine 10 is rotating at step 212, the procedure goes to step 214. If the engine 10 is not rotating, the procedure goes to step 213 where a count value of the number of times of ON of the solenoid valve 104 is reset, and then returns to step 209. At step 214, the microcomputer 118 turns the FET 117 OFF, thereby shutting down the power supply of the control circuit 102 by itself to end the start control of the engine 10.

As described above, the engine-powered tool 1 is configured such that when the switch means is turned ON, the start control means controls the switching element to start the engine, and when the engine has started, the start control means turns its own power off. Since the power is supplied from the battery to the start control means when the switch means is turned ON and the power supply to the starter motor is controlled by the start control means, the start control means can be operated when needed. When the switch means is turned ON, the start control means controls the switching element to start the engine, and when the engine has started, the start control means turns its own power off. Therefore, wasteful power consumption can be prevented by the start control device.

The switching element is, for example, a FET (Field Effect Transistor), and since the source and the drain of the FET are connected in series to a power supply circuit from the battery to the starter motor and the gate of the FET is connected to a microcomputer included in the start control means, PWM control can be performed with high accuracy by use of the microcomputer. The battery is a removable lithium-ion secondary battery, and the start control means monitors the battery voltage of the lithium-ion secondary battery and keeps the switching element in an OFF state when the battery voltage is low, thereby controlling so that the start by the starter motor is not attempted. Therefore, an excessive discharge of the battery can be prevented, and the life of the battery can be prolonged.

The engine-powered tool 1 includes temperature detecting means for measuring a temperature of the engine and electrically-operated choke means for enriching an intake fuel to the engine, and since the start control means activates the choke means in accordance with the temperature detected by the temperature detecting means, auto-choke means can be achieved, and the worker is free from a choke operation. Accordingly, the engine-powered tool 1 with enhanced usability can be provided.

The engine-powered tool 1 includes revolution detecting means for detecting the number of revolutions of the engine, and since the start control means stops the starter motor by determining the completion of a start operation of the engine by use of an output from the revolution detecting means, the starter motor can be appropriately driven for an appropriate period, and an efficient start operation can be performed without wastefully consuming the battery. Since the start control means monitors the temperature of the engine and the voltage of the battery, and changes a ratio and time for increasing a duty ratio of the PWM control in accordance with the temperature and the voltage, an engine-powered tool capable of performing a stable start operation hardly affected by the state of the battery, outside air temperature, and others can be realized.

As described above, in the engine-powered tool 1, when the engine is to be started by the starter motor, the PWM control is performed by use of the switching effect of the FETs, thereby performing the soft start in which the duty ratio of electric power to be supplied to the starter motor is gradually increased. For this reason, the starting current at the time of starting the starter motor is suppressed, and therefore, the starter motor can be driven by use of a small-sized lithium-ion battery with a low battery voltage. Also, since control is made so that the time for soft start is changed in accordance with the ambient temperature and battery voltage, operation defects of the control circuit and the solenoid valve due to a voltage drop caused by the starting current at the time of low temperatures can be effectively prevented, and the engine-powered tool can be stably operated.

In the foregoing, the present invention has been described based on the embodiment. However, the present invention is not limited to the foregoing embodiment and various modifications and alterations can be made within the scope of the present invention. For example, a grass cutter is taken as an example in the description of the engine-powered tool, but the present invention can be applied not only to the grass cutter but also to another engine-powered tool configured to drive a working tool by taking an engine as a driving source, such as a cutter, a chainsaw, or a lawn mower.

### industrial applicability

The present invention is applied to an engine-powered tool that drives a working tool such as a rotary blade by using an engine as a power source.

1-8. (canceled)

9. An engine-powered tool to be driven by an engine, the engine-powered tool comprising: a starter motor driven by electric power supplied from a battery to start the engine; start control means driven by the electric power from the battery to control rotation of the starter motor; and a switching element provided in series to a power supply circuit from the battery to the starter motor, opening and closing of the switching element being controlled by the start control means,
wherein when the starter motor is to be started, the start control means performs PWM control on the switching element so as to gradually increase a duty ratio.

10. The engine-powered tool according to claim 9, further comprising: switch means for operating the engine,
wherein when the switch means is turned ON, electric power is supplied from the battery to the start control means, and power supply to the starter motor is controlled by the start control means.

11. The engine-powered tool according to claim 10,
wherein the start control means starts the engine by controlling the switching element when the switch means is turned ON, and when the engine has been started, the start control means turns its own power off.

12. The engine-powered tool according to claim 9,
wherein the switching element is a FET, a source and a drain of the FET are connected in series to the power supply circuit from the battery to the starter motor and a gate of the FET is connected to a microcomputer included in the start control means.

13. The engine-powered tool according to claim 9,
wherein the battery is a removable lithium-ion secondary battery, the start control means monitors a battery voltage of the lithium-ion secondary battery and keeps the switching element in an OFF state when the battery voltage is low.

14. The engine-powered tool according to claim 9, further comprising:
temperature detecting means for measuring a temperature of the engine; and electrically-operated choke means for enriching an intake fuel to the engine,
wherein the start control means activates the choke means in accordance with the temperature detected by the temperature detecting means.

15. The engine-powered tool according to claim 9, further comprising:
revolution detecting means for detecting the number of revolutions of the engine,
wherein the start control means stops the starter motor by determining completion of a start operation of the engine by use of an output from the revolution detecting means.

16. The engine-powered tool according to claim 9,
wherein the start control means monitors a temperature of the engine and a voltage of the battery, and changes a ratio and time for increasing a duty ratio of the PWM control in accordance with the temperature and the voltage.
